(19) United States
(12) Patent Application Publication
(10) Pub. No.: US 2021/0295715 A1
(43) Pub. Date: Sep. 23, 2021

(54) UAV (UNMANNED AERIAL VEHICLE) LOGISTIC OPERATIONAL MISSION PLANNING AND MANAGEMENT SYSTEM AND METHOD THEREOF

(71) Applicant: Min-Chung Gia, Taipei City (TW)

(72) Inventor: Min-Chung Gia, Taipei City (TW)

(21) Appl. No.: 16/823,015

(22) Filed: Mar. 18, 2020

(51) Int. Cl. G08G 5/00; G08G 5/04; G05D 1/10; G05D 1/06; B64C 39/02; G06T 17/00

(52) U.S. Cl. CPC G08G 5/0034; G08G 5/0069; G08G 5/0086; G08G 5/045; B64C 2201/126; G05D 1/0646; B64C 39/024; G06T 17/005; G05D 1/106

(57) ABSTRACT

A UAV (unmanned aerial vehicle) logistic operational mission planning and management system present hereof for safety of all flight space users inside flyable airspace and the ground crew in an irresistible trend of commercial operations of UAVs to be implemented is to construct a terrain model for a flyable airspace as a platform on which a system for integrating operational mission planning and air traffic control/management is created. A UAV logistic operational mission planning and management system is an expandable, flexible and adaptable system responding changeable requirements, quantities, technologies, business models and applications and preserving a manned air traffic control interface for operations and managements of multiple UAVs in flyable airspace monitored by a UAV air traffic control center safely and reliably.

### BACKGROUND OF THE INVENTION

### 1. Field of the Invention

The present disclosure relates to logistics, particularly a logistic operational mission planning and management system based on unmanned aerial vehicles.

### 2. Description of the Prior Art

UAV (unmanned aerial vehicle) technologies gradually matured nowadays have proved effective in applications extensively. Moreover, statutes and regulations amended constantly are diversifying future UAV applications and promoting safe flights as well as efficacious management which are imperative for controllable UAV flights and optimized flyable airspace and regarded as main subjects to be researched and developed in all countries.

Flight mission planning and air traffic control/management of UAV operation should be completed in a prototype system based on services, roles, responsibilities, infrastructures, performance requirements, information structure, software functions and data exchange protocols. The prototype system is an expandable, flexible and adaptable system responding changeable requirements, quantities, technologies, business models and applications and preserving a manned air traffic control interface. Subject to surveillances of a UAV air traffic control center (ATCC), UAVs are operated and managed in flyable airspace in which all UAVs are flying safely and reliably.

In a remote-control flight mission beyond the visual range, a UAV on which a parcel is carried for a destination 15 kilometers away from a start point has to fly in flyable airspace along a flight path created by a mission planning system according to a database for elevations and terrains. The flight path which has been planned, simulated and tested complies with applicable statutory and regulatory requirements for flyable airspace including electronic fence, availability of flyable airspace, temporary area and restricted area. The flight path is a proper, safe and economically effective route along which a UAV does not collide with another UAV operated in the same airspace and no barrier except emergencies exists.

In the issued U.S. patents of U.S. Pat. No. 6,317,690 and U.S. Pat. No. 6,401,038 for terrain data processing, terrain awareness and an early warning system granted to the patent applicant, a set of terrain nodes with the their heights greater than the minimum flight altitude are collected according to positioning and flight conditions for creation of a structured terrain model with which algorithms related to collision checks, mountain borders and region growths are employed for no collisions between UAVs and terrains, dynamic path planning based on visibility graphs, and reduction of instant computing resources.

Having reviewed prior arts, the patent applicant further develops a UAV (unmanned aerial vehicle) logistic operational mission planning and management system with which a tree data structure of a terrain model for airspace is constructed. Based on the tree data structure of the terrain model, a flight mission path at which hazards and barriers are prevented is planned for airway capacity planning and air traffic control, surveillances of flights within an airway, emergency management, fulfillment of technology for UAV logistics operation, and healthy development of the industry.

### SUMMARY OF THE INVENTION

The present disclosure aims to offer a UAV (unmanned aerial vehicle) logistic operational mission planning and management system with which a terrain model for flight space is constructed and a flight mission path is planned for UAVs flying at an automatic or manual remote-control mode safely without collision with terrains or unexpected barriers, applications to over-the-horizon flights, and available flight space maximized.

A UAV logistic operational mission planning and management system in the present disclosure comprises:

a digital terrain modeling subsystem for construction of a tree data structure of a terrain model in flight space;

a flight mission path planning subsystem with which a flight mission path for hazard/barrier preventions is planned by referring to the tree data structure of the terrain model;

an airway capacity planning & traffic flow control subsystem for airway capacity planning and traffic flow control based on the flight mission path; and

a UAV operation, air traffic control and monitoring subsystem for surveillances of UAV flights in an airway and interventions of emergency events.

The digital terrain modeling subsystem comprises a cloud terrain database module and a terrain modeling module: the cloud terrain database module is used to access a DTM (digital terrain model) database, a DSM (digital surface model) database, or a no-fly zone & miscellaneous database through which a plurality of elevation-related data is collected and sent to the terrain modeling module for construction of a terrain model with a plurality of elevation-related data stacked.

The flight mission path planning subsystem comprises a static mission planning module and a dynamic mission planning module: the static mission planning module is used in creating a flight mission path for a scheduled and planned mission in advance; the dynamic mission planning module is used in creating a flight mission path for an unscheduled or unplanned mission or a flight mission path immediately planned for hazard/collision preventions.

Each of the static mission planning module and the dynamic mission planning module is connected with a macro path planning unit and/or a micro path planning unit: the macro path planning unit is capable of producing a straight flight path with a simple and fixed altitude for topographies relatively flat or less undulated in a terrain model; the micro path planning unit is characteristic of generating a flight path for topographies complicated and/or flight altitudes changeable to be bypassed or beyond the limitation of the flight altitude in a flight segment of an airway.

The tree data structure is a QUADTREE or OCTREE data structure.

A UAV logistic operational mission planning and management method, comprising:

a tree data structure of a terrain model is constructed for flight airspace and characteristic of each node corresponding to a location in the terrain model and having elevation-related data with respect to the location;

a mission path for hazard/barrier preventions is planned based on the tree data structure of the terrain model;

airway capacity planning and traffic flow control are effectuated according to the mission path; and

a UAV flying in the airway is monitored for emergency management.

A tree data structure is re-stacked with separate tree structures, each of which is constituted by a plurality of elevation-related data, in a stack process during which typical values corresponding to nodes in a separate tree structure are checked such that stacking is completed through node merging and node splitting; alternatively, a plurality of elevation-related data are stacked such that a tree data structure is constructed through node merging and node splitting.

A tree data structure is created according to variable resolution modeling. In modeling, each tree layer of a tree data structure is given a distinct node resolution and a lower-level tree layer features a higher node resolution. For an area with its terrain feature to be strengthened, the nodes corresponding to the area can be separated and merged into a lower-level tree layer for a higher node resolution; for an area with no terrain feature strengthened or a feature negligible, the nodes corresponding to the area can be merged into a higher-level tree layer for a lower node resolution.

Moreover, a tree data structure is created according to multiple resolution modeling. In modeling, each tree layer of a tree data structure is given a distinct node resolution and a lower-level tree layer features a higher node resolution. From the lowest-level tree layer, terrain features of all nodes at a tree layer, based on setting conditions, are incorporated into corresponding nodes at a higher-level tree layer and re-incorporated into nodes at a further higher-level tree layer and root nodes of the tree data structure finally.

The method for flight path planning is shown as follows:

a start point and a destination are created in a terrain model for development of a ground track related to a straight flight path;

a hazardous area, which consists of a group of nodes in the terrain model, along the straight flight path is recognized through collision prevention checks based on flight altitudes and the ground track for the straight flight path;

a set of nodes beyond the hazardous area are defined as candidate waypoints in flight mission path planning by collision prevention checks;

a visibility graph based on the candidate waypoints is created for development of collision-free flight segments by flight path searching; and
a flight mission path with flight segments is created by linking the start point and the destination and a configuration file for the flight mission path is derived by accesses to corresponding nodes in the tree data structure of the terrain model.

### BRIEF DESCRIPTION OF THE DRAWINGS

FIG. 1 is a block diagram for architecture of a UAV (unmanned aerial vehicle) logistic operational mission planning and management system;

FIG. 2 is a block diagram for architecture of a digital terrain modeling subsystem in a UAV logistic operational mission planning and management system;

FIG. 3 is a block diagram for architecture of a flight mission path planning subsystem in a UAV logistic operational mission planning and management system;

FIG. 4 is a schematic view for planning and applications of a barrier-free flight path;

FIG. 5 is a diagram for macro path planning in an embodiment;

FIG. 6 is a diagram for micro path planning in an embodiment;

FIG. 7 is a flowchart for a UAV logistic operational mission planning and management method;

FIG. 8 is a flowchart for flight mission path planning;

FIG. 9 is a schematic view for construction of a tree data structure in stacking;

FIG. 10 is a flowchart for construction of a tree data structure in stacking;

FIG. 11 is a schematic view for construction of a tree data structure based on variable resolution modeling; and

FIG. 12 is a schematic view for construction of a tree data structure based on multiple resolution modeling.

### DETAILED DESCRIPTION OF THE PREFERRED EMBODIMENTS

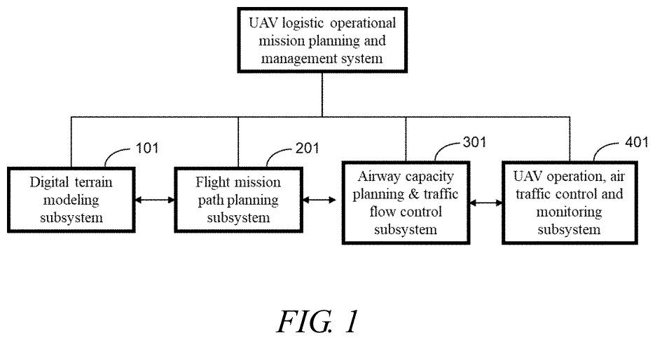

Referring to FIG. 1, which illustrates a UAV (unmanned aerial vehicle) logistic operational mission planning and management system with four major subsystems:

1. Digital terrain modeling subsystem 101: The subsystem is used to construct a tree data structure of a terrain model for flight space by a first-build/last-stack or first-stack/last-build method wherein the tree data structure is characteristic of the sequence to be adjusted with a variable resolution modeling method or a multiple resolution modeling method.

2. Flight mission path planning subsystem 201: With a static mission planning mode and a dynamic mission planning mode for practices of macro path planning and/or micro path planning of various terrain models, the subsystem for UAV commercial operations is used in planning and developing a comprehensive flight mission path for hazard/barrier preventions by referring to the tree data structure of a terrain model.

3. Airway capacity planning & traffic flow control subsystem 301: The subsystem refers to a flight mission path for airway capacity planning and air traffic control in which taking-off and landing areas, UAV operations and flight managements are covered and further applications of blockchain technology to airway capacity planning, UAV safe separation distance and traffic flow control.

4. UAV operation, air traffic control and monitoring subsystem 401: The subsystem is provided with an interface through which an air traffic control center is communicated for surveillances of UAV flights, interventions of emergency events, display of flight mission path status and availability of a flyable airspace and particularly a UAV pilot interface.

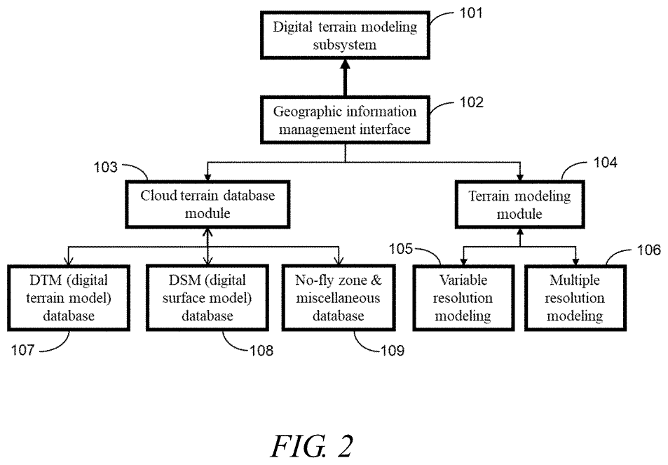

Referring to FIG. 2, which illustrates the digital terrain modeling subsystem 101 comprises a cloud terrain database module 103 and a terrain modeling module 104: the cloud terrain database module 103 for construction, maintenance, access and other functions of a terrain database is used to access a DTM (digital terrain model) database 107, a DSM (digital surface model) database 108, or a no-fly zone & miscellaneous database 109 through which a plurality of elevation-related data (for example, towers, high-rises or restricted areas) is collected and sent to the terrain modeling module 104 for construction of a terrain model with a plurality of elevation-related data stacked; the terrain modeling module 104 is used to create a terrain model as required with a method of variable resolution modeling 105 or multiple resolution modeling 106. The cloud terrain database module 103 further comprises a geographic information management interface 102 as a window through which the cloud terrain database module 103 and the terrain modeling module 104 communicate with each other and all kinds of input data/parameters in the cloud terrain database module 103 or outcomes in the terrain modeling module 104 are integrated and displayed.

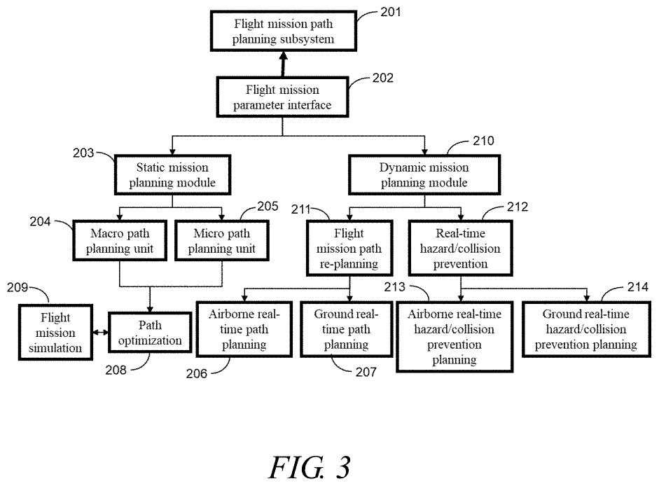

Referring to FIG. 3, which illustrates the flight mission path planning subsystem 201 comprises a static mission planning module 203 and a dynamic mission planning module 210: the static mission planning module 203 is used in creating a flight mission path for a scheduled and planned mission in advance; the dynamic mission planning module 210 is used in creating a flight mission path for an unscheduled or unplanned mission or a flight mission path immediately planned for hazard/collision preventions. The static mission planning module 203 and the dynamic mission planning module 210 rely on a flight mission parameter interface 202 as a window for communications in between.

The static mission planning module 203 is connected with a macro path planning unit 204 and a micro path planning unit 205: the macro path planning unit 204 is capable of producing a straight flight path with a simple and fixed altitude based on the principle of macro path planning for topographies relatively flat or less undulated in a terrain model; the micro path planning unit 205 is characteristic of generating a flight path for topographies complicated and/or flight altitudes changeable based on the principle of micro path planning for terrain features to be bypassed or beyond the limitation of a flight altitude in a flight segment of an airway. A path optimization 208 and even a flight mission simulation 209, if necessary, should be available to a planned flight mission path.

Similarly, strategies of macro path planning and micro path planning are applicable to the dynamic mission planning module 210 in which flight mission path re-planning 211 in a mission is initiated particularly for any change in a destination or a UAV's misadventure such as unregistered barrier and task conflict alert that should be handled through airborne real-time path planning 206 or ground real-time path planning 207. Moreover, the dynamic mission planning module 210 is available to real-time hazard/collision prevention 212 with situations handled through airborne real-time hazard/collision prevention planning 213 or ground real-time hazard/collision prevention planning 214 similarly.

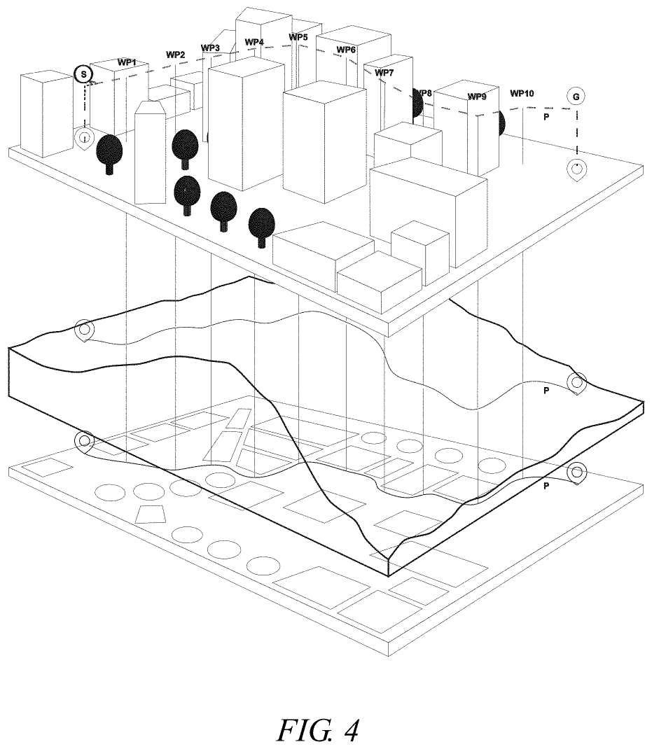

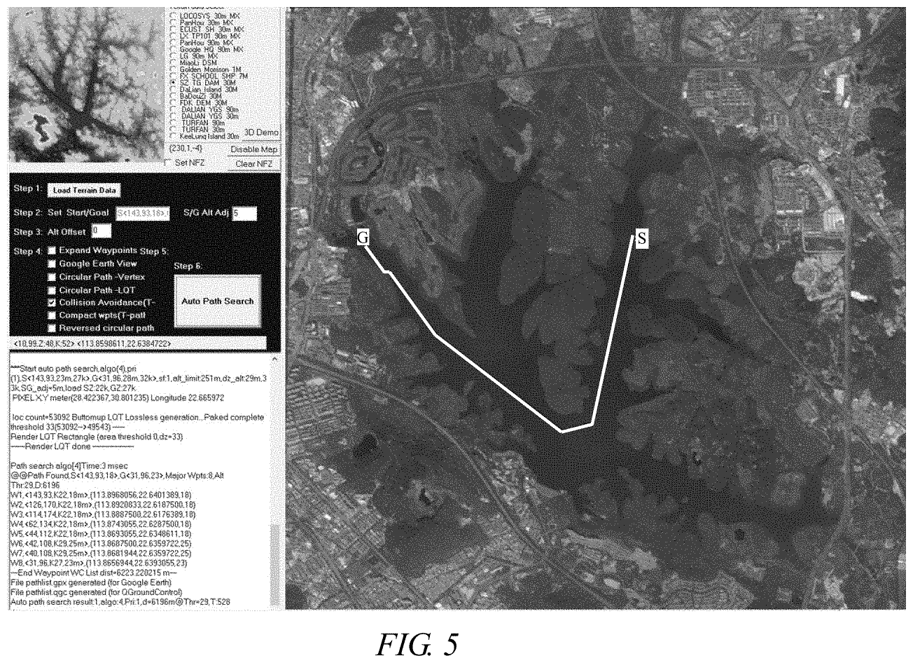

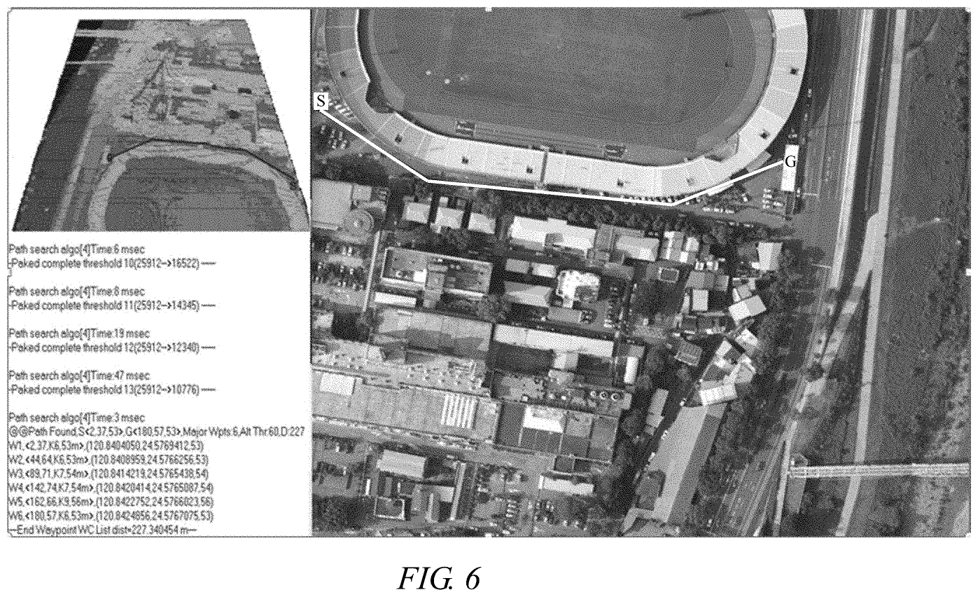

Referring to FIGS. 3 and 4, which illustrate some waypoints, WP1, WP2 and WP10, between a start point S and a destination G are decided by the flight mission path planning subsystem 201, a flight segment is produced with any two separate waypoints (WP1, WP2 . . . and WP10) connected to each other, and a flight mission path P is created by linking all produced flight segments. Accordingly, a straight flight path with a simple and fixed altitude for topographies relatively flat or less undulated is planned by the macro path planning unit 204 (FIG. 5); however, a particular flight mission between buildings is probably inevitable and satisfied through the micro path planning unit 205 because of terrain features to be bypassed or beyond the limitation of a flight altitude in some flight segments or complicated terrains affecting a flight segment for taking-off or landing (FIG. 6).

Moreover, as shown in FIG. 1, the airway capacity planning & traffic flow control subsystem 301 for optimization of available flyable airspace is used in planning a static airway based on a terrain model for the flyable airspace in the beginning and effective in UAV safe separation, traffic flow control, and creation of a database for overall airway planning in the flyable airspace. Accordingly, all UAV flights in the flyable airspace are incorporated into a unified management and monitoring system and recognized, tracked and monitored by the UAV operation, air traffic control and monitoring subsystem 401.

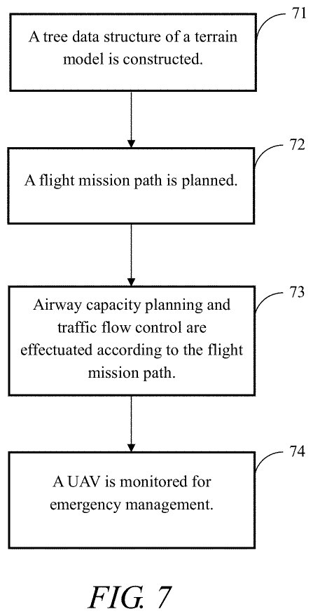

Referring to FIG. 7, which illustrates a UAV logistic operational mission planning and management method with applications to pre-mission planning or real-time status planning, as shown in following steps:

71. A tree data structure, QUADTREE or OCTREE, of a terrain model is constructed for flight airspace and characteristic of each node corresponding to a location in the terrain model wherein a node generated from digital terrain elevation data (DTED) or a digital surface model (DSM) comprises elevation-related data with respect to the location and is accessed for a topographic height;

72. A flight mission path for hazard/barrier preventions is planned based on the tree data structure of the terrain model;

73. Airway capacity planning and traffic flow control are effectuated according to the flight mission path; and

74. A UAV flying in the airway is monitored for emergency management.

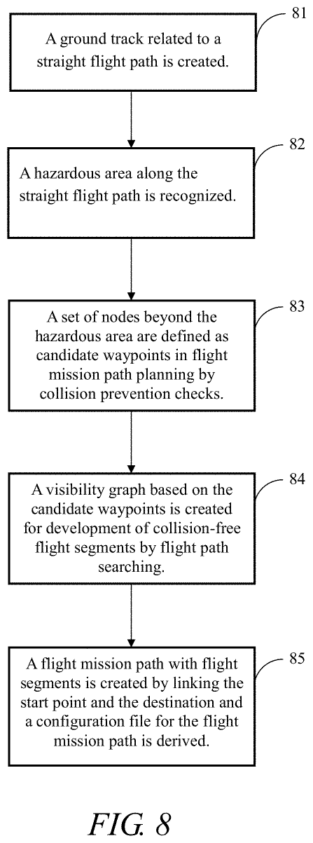

Referring to FIG. 8, which illustrates a flowchart for flight mission path planning, as shown in following steps:

81. A start point and a destination are created in a terrain model for development of a ground track related to a straight flight path;

82. A hazardous area, which consists of a group of nodes in the terrain model, along the straight flight path is recognized through collision prevention checks based on flight altitudes and the ground track for the straight flight path;

83. A set of nodes beyond the hazardous area are defined as candidate waypoints in flight mission path planning by an algorithm for collision prevention checks;

84. A visibility graph based on the candidate waypoints is created for development of collision-free flight segments by an algorithm for flight path searching; and

85. A flight mission path with flight segments is created by linking the start point and the destination and a configuration file for the flight mission path is derived by accesses to corresponding nodes in the tree data structure of the terrain model.

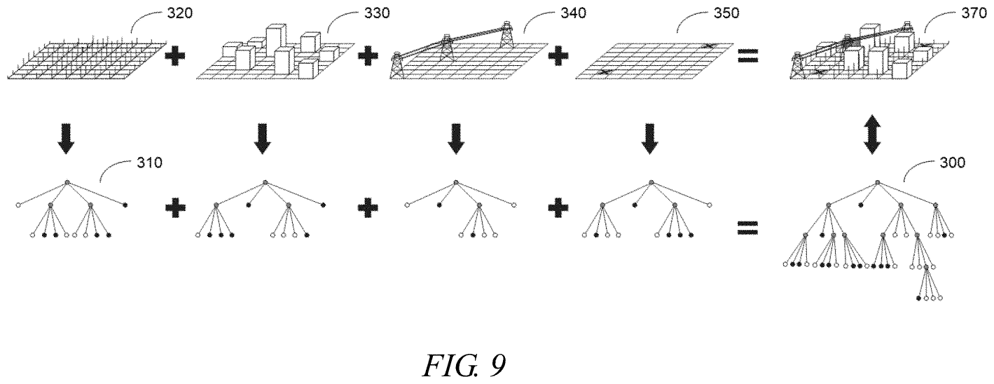

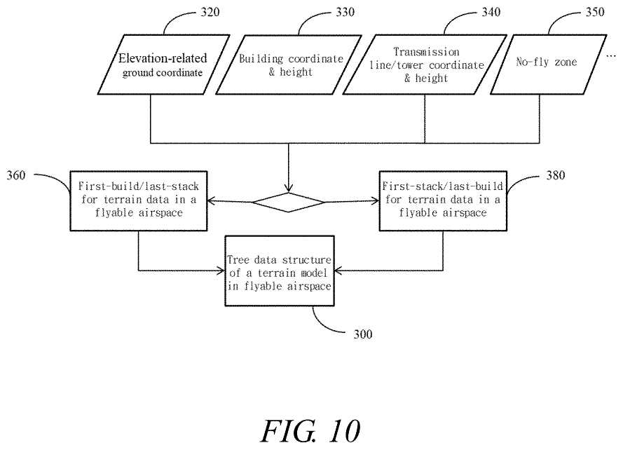

Referring to FIGS. 9 and 10, which illustrate how a tree data structure is stacked. In the first mode, a tree data structure 300 is re-stacked with separate tree structures 310, each of which is constituted by a plurality of elevation-related data, wherein a separate tree structure 310 contains information such as elevation-related ground coordinate 320, building coordinate & height 330, transmission line/tower coordinate & height 340, no-fly zone 350, etc. The so-called first-build/last-stack 360 means typical values corresponding to nodes in a separate tree structure 310 are checked first and a stack process is completed by an algorithm for node merging and an algorithm for node splitting later. Alternatively, the so-called first-stack/last-build 380 means a complete terrain model 370 is stacked with a plurality of elevation-related data first and the tree data structure 300 is created by an algorithm for node merging and an algorithm for node splitting later. First-build/last-stack for overall flight mission path planning or first-stack/last-build for detailed flight mission path planning can be used in modeling flexibly for the same result.

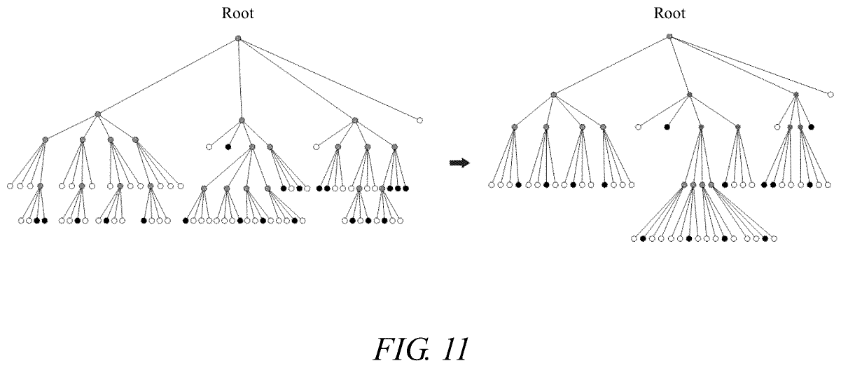

Referring to FIG. 11, which illustrates a tree data structure is created according to variable resolution modeling. In modeling, each tree layer of a tree data structure 300 is given a distinct node resolution and a lower-level tree layer features a higher node resolution. With multiple tree structures 310 stacked, the node resolution of each tree layer can be strengthened or neglected as required. For an area with its terrain feature to be strengthened, the nodes corresponding to the area can be separated and merged into a lower-level tree layer for a higher node resolution until the lowest-level layer, i.e., leaf node, is reached. For an area with no terrain feature strengthened or a feature negligible, the nodes corresponding to the area can be merged into a higher-level tree layer for a lower node resolution until the highest-level layer, i.e., root node, is reached. For example, a lower-level tree layer has a higher node resolution with which the terrain feature of a high-density architectural complex can be strengthened and a higher-level tree layer has a lower node resolution with which the terrain feature of an open mountain or lake is presented.

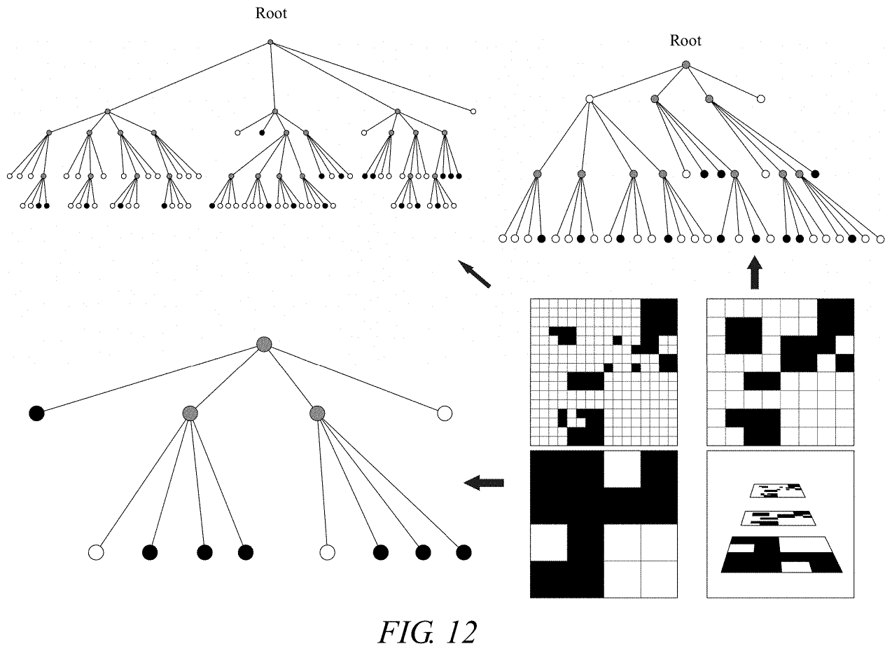

Referring to FIG. 12, which illustrates a tree data structure is created according to multiple resolution modeling; that is, each tree layer of a tree data structure 300 is given a distinct node resolution and a lower-level tree layer features a higher node resolution. From the lowest-level tree layer (leaf node), terrain features of all nodes at a tree layer, based on setting conditions, are incorporated into corresponding nodes at a higher-level tree layer and re-incorporated into nodes at a further higher-level tree layer and root nodes of the tree data structure finally for a stacked pyramid. Accordingly, there are more nodes at a lower-level tree layer at which more detailed terrain features are saved.

In the multiple resolution modeling, any detailed information which can be presented by an approximate value or an equivalent value is incorporated into root nodes. For a flight mission, an algorithm for flight path searching will be initiated from any lower-level tree layer in a tree data structure or further from a higher-level tree layer in the case of no proper flight path found at the previous lower-level tree layer for immediate processing of variable flight parameters such as velocity, altitude and changed destination.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A UAV (unmanned aerial vehicle) logistic operational mission planning and management system, comprising:
a digital terrain modeling subsystem for construction of a tree data structure of a terrain model in flight space;
a flight mission path planning subsystem with which a flight mission path for hazard/barrier preventions is planned by referring to the tree data structure of the terrain model;
an airway capacity planning & traffic flow control subsystem for airway capacity planning and traffic flow control based on the flight mission path; and
a UAV operation, air traffic control and monitoring subsystem for surveillances of UAV flights in an airway and interventions of emergency events.

2. The UAV logistic operational mission planning and management system as claimed in claim 1 wherein:
the digital terrain modeling subsystem comprises a cloud terrain database module and a terrain modeling module: the cloud terrain database module is used to access a DTM (digital terrain model) database, a DSM (digital surface model) database, or a no-fly zone & miscellaneous database through which a plurality of elevation-related data is collected and sent to the terrain modeling module for construction of a terrain model with a plurality of elevation-related data stacked.

3. The UAV logistic operational mission planning and management system as claimed in claim 1 wherein:
the flight mission path planning subsystem comprises a static mission planning module and a dynamic mission planning module: the static mission planning module is used in creating a flight mission path for a scheduled and planned mission in advance; the dynamic mission planning module is used in creating a flight mission path for an unscheduled or unplanned mission or a flight mission path immediately planned for hazard/collision preventions.

4. The UAV logistic operational mission planning and management system as claimed in claim 3 wherein:
each of the static mission planning module and the dynamic mission planning module is connected with a macro path planning unit and/or a micro path planning unit: the macro path planning unit is capable of producing a straight flight path with a simple and fixed altitude for topographies relatively flat or less undulated in a terrain model; the micro path planning unit is characteristic of generating a flight path for topographies complicated and/or flight altitudes changeable to be bypassed or beyond the limitation of a flight altitude in the flight segment of an airway.

5. The UAV logistic operational mission planning and management system as claimed in claim 1 wherein the tree data structure a QUADTREE or OCTREE data structure.

6. A UAV logistic operational mission planning and management method, comprising:
a tree data structure of a terrain model is constructed for flight airspace and characteristic of each node corresponding to a location in the terrain model and having elevation-related data with respect to the location;
a flight mission path for hazard/barrier preventions is planned based on the tree data structure of the terrain model;
airway capacity planning and traffic flow control are effectuated according to the flight mission path; and
a UAV flying in the airway is monitored for emergency management.

7. A UAV logistic operational mission planning and management method as claimed in claim 6 wherein:
a tree data structure is stacked with a plurality of elevation-related data derived from a DTM (digital terrain model) database, a DSM (digital surface model) database, or a no-fly zone & miscellaneous database.

8. The UAV logistic operational mission planning and management method as claimed in claim 7 wherein:
a tree data structure is re-stacked with separate tree structures, each of which is constituted by a plurality of elevation-related data, in a stack process during which typical values corresponding to nodes in a separate tree structure are checked such that stacking is completed through node merging and node splitting; alternatively, a plurality of elevation-related data are stacked such that a tree data structure is constructed through node merging and node splitting.

9. The UAV logistic operational mission planning and management method as claimed in claim 8 wherein:
a tree data structure is created according to variable resolution modeling for which each tree layer of a tree data structure is given a distinct node resolution and a lower-level tree layer features a higher node resolution: (1) an area with its terrain feature to be strengthened: the nodes corresponding to the area can be separated and merged into a lower-level tree layer for a higher node resolution; (2) an area with no terrain feature strengthened or a feature negligible: the nodes corresponding to the area can be merged into a higher-level tree layer for a lower node resolution.

10. The UAV logistic operational mission planning and management method as claimed in claim 8 wherein:
a tree data structure is created according to multiple resolution modeling for which each tree layer of a tree data structure is given a distinct node resolution and a lower-level tree layer features a higher node resolution such that terrain features of all nodes at a tree layer, based on setting conditions, from the lowest-level tree layer are incorporated into corresponding nodes at a higher-level tree layer and re-incorporated into nodes at a further higher-level tree layer and root nodes of the tree data structure finally.

11. The UAV logistic operational mission planning and management method as claimed in claim 6 wherein:
a start point and a destination are created in a terrain model for development of a ground track related to a straight flight path;
a hazardous area, which consists of a group of nodes in the terrain model, along the straight flight path is recognized through collision prevention checks based on flight altitudes and the ground track for the straight flight path;
a set of nodes beyond the hazardous area are defined as candidate waypoints in flight mission path planning by collision prevention checks;
a visibility graph based on the candidate waypoints is created for development of collision-free flight segments by flight path searching; and
a flight mission path with flight segments is created by linking the start point and the destination and a configuration file for the flight mission path is derived by accesses to corresponding nodes in the tree data structure of the terrain model.

12. The UAV logistic operational mission planning and management method as claimed in claim 11 wherein flight mission path planning consists of static mission planning and dynamic mission planning: the static mission planning is used in creating a flight mission path for a scheduled and planned mission in advance; the dynamic mission planning is used in creating a flight mission path for an unscheduled or unplanned mission or a flight mission path immediately planned for hazard/collision preventions.

13. The UAV logistic operational mission planning and management method as claimed in claim 12 wherein flight mission path planning features (1) macro path planning through which a straight flight path with a simple and fixed altitude for topographies relatively flat or less undulated in a terrain model is created; (2) micro path planning through which a flight path for topographies complicated and/or flight altitudes changeable to be bypassed or beyond the limitation of a flight altitude in a flight segment of an airway is created.
